(19) United States
(12) Patent Application Publication
(10) Pub. No.: US 2005/0120844 A1
(43) Pub. Date: Jun. 9, 2005

(54) Slicing method and device

(76) Inventor: Gunther Weber, Breidenbach (DE)

Correspondence Address: GIFFORD, KRASS, GROH, SPRINKLE & CITKOWSKI, P.C, PO BOX 7021, TROY, MI, 48007-7021, US

(21) Appl. No.: 10/480,704

(22) PCT Filed: Apr. 11, 2002
(86) PCT No.: PCT/EP02/04058

(30) Foreign Application Priority Data
Jun. 29, 2001 (DE) 101 31 701.8

(51) Int. Cl. B26D 7/00

(52) U.S. Cl. 83/35; 83/360; 83/932; 83/76.8; 83/758

(57) ABSTRACT

The invention relates to a method for slicing food products having an irregular inner structure such as sausages or ham, wherein the products (11) are cut into slices (S) and especially offset portions or stacked portions are formed and transported away from the slicing area (31). During said slicing process, information on the contour and structure of the slices of products is obtained by means of an opto-electronic detector device in a series of successive detection steps (E) by illuminating the slicing area, whereupon the illuminated rays reflected from the cutting surfaces (13) of the slices of product which are to be respectively separated and from the edge area (15) of said slices are detected and evaluated Said illumination is carried out in at least one and preferably in all of the detection steps (E) in several directionally independent components (k) which are different from each other at least with respect to an illumination parameter. The invention also relates to a slicing device which is especially suitable for carrying out the inventive slicing method.

The invention relates to a method for the slicing of food products having an irregular inner structure such as sausage or ham, in which the products are cut into slices and in particular overlapping portions or stacked portions are formed and transported away from the slicing region and in which information on the contour and on the structure of the product slices is obtained during slicing by means of an optoelectronic detection device in a series of detection procedures, in that the slicing region is illuminated and illuminating radiation reflected from the respective cut surfaces of the slices to be cut off from the product and reflected from the marginal region of the slices is detected and evaluated.

The invention further relates to an apparatus for the slicing of food products having an irregular inner structure such as sausage or ham, with which the products are cut into slices and portions or stacked portions, in particular overlapping portions or stacked portions, are formed and are transported away from the slicing region, having a lighting device for the illumination of the slicing region including at least one radiation source, having a detection device for illuminating radiation reflected from the respective cut surfaces of the slices to be cut off from the product and reflected from the marginal region of the slices and having an evaluation device for the evaluation of the radiation detected.

It is usually demanded in practice that the slices produced when slicing food products or the portions produced from the slices should have a constant pre-determined weight at least within certain tolerance limits. The weight can be set by changing the slice thickness at the slicing machine, with differences being able to occur which are, however, no longer tolerable in particular when—as is usually the case in practice—the products have an irregular inner structure over the product length with product components of different density and/or a varying cross-sectional shape over the product length. These irregularities can basically be corrected by changing the slice thickness during slicing. For this purpose, one requires information on the contour and on the structure of the product and of the product slices.

It is known from DE 199 06 021 A1 to illuminate the environment of the product end face with the help of an illumination element arranged areally along the longitudinal direction of the product and to detect the contour of the end face on the basis of the contrast between the end face and its environment by means of an optical detection device. DE 199 06 021 A1 also describes the arrangement of an additional illumination assembly in front of the end face in order to be able to determine its structure.

With this known arrangement, the end face of the product may not be illuminated too strongly since otherwise the contrast achieved by means of the environmental lighting will again be reduced so far that a contour determination by means of the optical detection device is no longer possible with sufficient accuracy. Although the known arrangement provides good results in many applications, problems can in particular occur when a strong brightening of the cut surfaces is required for the determination of the slice structure in order to produce a sufficiently high contrast between different components of the product.

It is the object of the invention to improve this known solution and to provide a method and an apparatus of the initially named kind which permit both the contour and the structure of the respective product slices to be cut off to be determined for any desired products to be sliced with as high a precision as possible during the slicing procedure.

This object is satisfied, on the one hand, by the features of the method claim 1 and in particular in that the illumination is effected in at least one detection procedure, and preferably in every detection procedure, in a plurality of direction-independent components which differ from one another at least with respect to an illumination parameter.

The object underlying the invention is moreover satisfied by the features of the apparatus claim 18 and in particular in that the lighting device for the production of a contrast sufficient for the detection of the contour and of the structure of the product slices between the cut surface and its marginal region, on the one hand, and between different components of the product on the cut surface, on the other hand, is operable such that the illumination can be effected in at least one detection procedure, and preferably in each detection procedure, in a plurality of detection-independent components which differ from one another at least with respect to an illumination parameter.

In accordance with the invention, the illumination includes a plurality of direction-independent components. The illumination components can differ from one another, for example, with reference to the wavelength used or to the wavelength range used and/or with respect to the intensity of the radiation used or to the intensity of illumination produced in the respectively illuminated region. Alternatively or additionally, there can be a difference in the polarization properties of the radiation used. Furthermore, the illumination components can be effected simultaneously or after one other timewise, i.e. the or an illumination parameter to be distinguished is, in this process, the time at which the illumination components are respectively effected.

Furthermore, the illumination components can be effected either from one single direction, and in particular by means of one single radiation source, or from different directions, and in particular by means of a plurality of radiation sources spatially separated from one another.

Due to the division of the illumination in accordance with the invention into a plurality of direction-independent components, they can be set individually and directly matched to the respective application in order to produce sufficient contrast in total for the contour and structure detection of the product slices between the cut surface and its marginal region, on the one hand, and between different components of the product and the cut surface, on the other hand.

When different wavelengths are used, for example, the cut surface can be brightened by radiation of one wavelength by so much that it stands out from the darker environment in a manner sufficient for the contour detection. For this contour detection, the radiation intensity can generally be selected to be as high as possible without taking the structure detection into account since radiation having a different wavelength is used for the structure detection and can in turn be directly matched to the components of the product.

In accordance with the invention, the illumination of the cut surface taking place for the structure detection can furthermore in turn be divided into individual illumination components. These components can e.g. likewise have different wavelengths which are each directly matched to a component of the product in order to produce a particularly good contrast between the components of the product such that the components of the product are distinguished from one another on the detection of or on the evaluation of the radiation reflected from the slicing region.

To distinguish between fat components and lean components, for example, red light can thus be used for the lean component and blue light for the fat component, whereas e.g. yellow light is used for the illumination component provided for the detection of the slice contour.

On the simultaneous effecting of some or all illumination components, the contour detection and the structure detections take place on the same product slice. A detection procedure is preferably carried out on each slice on the slicing of the product.

In the case of illumination components effected simultaneously which differ from one another e.g. with respect to the radiation and/or with respect to the intensity of the radiation used or of the intensity of illumination produced in the slicing region, the detection of the reflected radiation can take place by means of one single sensor which can separate the different wavelengths and which is provided, for example, in the form of a color camera. The detection device can also include a plurality of individual sensors which are each provided for the detection of radiation of a specific wavelength or of a specific wavelength range. Black and white cameras provided e.g. with suitable filter devices can be used as such individual sensors.

Alternatively, some or all components of the illumination can be effected after one other timewise. A single radiation source can e.g. be used which is capable of emitting the radiation for the individual illumination components at very short time intervals. For example, a pulsed radiation source can be used with which the slicing region can be exposed in series to radiation of different wavelengths and/or intensities.

For the detection of the radiation reflected from the slicing region, one single sensor can e.g. be used which can be operated in accordance with the time sequence of the illumination components and which can in particular be read out using the repeat rate pre-determined by the radiation source. With such a synchronization between the illumination and the radiation detection, i.e. between the transmitter and the receiver, a plurality of shots associated in each case with an illumination component can be taken.

The pieces of information gained from single shots can subsequently be evaluated and assembled to form joint information on both the contour and the structure of the product slices.

Instead of a single sensor, a plurality of single sensors can also be used for the detection of the reflected radiation which can be read out in series in accordance with the time sequence of the illumination components.

If the individual illumination components of a detection procedure are effected after one other timewise, this can take place, in a variant of the invention, for each detection procedure on a single product slice, i.e. the contour and structure detections each take place on one single product slice. Comparatively little time is available in this process for the transmission of the radiation associated with the individual illumination components and for its detection so that a relatively fast image processing, or at least a fast storing, of the image data taken with the detection device must be provided, in particular with high-performance slicing machines.

Alternatively, each detection procedure can include a plurality of product slices. The individual illumination components are effected in after one another timewise in this process and are spread over different product slices and in particular over product slices directly following one another. Information can, for example, be gained on one product slice about its structure and on another product slice about its contour.

The detection of the slice structure can in turn be spread over a plurality of slices following one another. If illuminating radiation of different wavelengths is used, sufficient contrast between the cut surface and the marginal region can e.g. be provided by yellow light in a first illumination component for the contour detection, while the lean component can be emphasized by red light on the next slice and the fat component of the product can be emphasized by blue light on the next-but-one slice. The pieces of information gained at the three product slices are compiled to form joint information on the evaluation. It is assumed for each piece of information gained on one of the slices that it is also present for the two other slices, i.e. is constant over the slices associated with the respective detection procedure. The individual product slices of a detection procedure are considered as a single slice in this respect.

In a particularly preferred embodiment of the invention, provision is made, for the production of the contrast between the cut surface and its marginal region, that a higher intensity of illumination is produced in the latter than on the cut surface.

In this lighting of the slicing region, also known as inverse illumination, the cut surface appears as a dark area with respect to the marginal region. On the brightening of the cut surface for the production of sufficient contrast between the different components of the product, the radiation intensity can generally be selected to be of any size without any consideration of the illumination component provided for the lighting of the marginal region if the illumination components differ from one another with respect to an illumination parameter such that it is possible to distinguish between the individual illumination components on the detection or on the evaluation of the radiation reflected overall from the slicing region.

The wavelength range visible to the human eye is preferably used on the illumination with radiation. Generally, some or all illumination components can also alternatively be effected using non-visible radiation.

The apparatus in accordance with the invention preferably includes a luminous frame or a luminous tunnel, such as is described, for example, in the initially mentioned DE 199 06 021 A1, for the illumination of the marginal region.

At least one radiation source arranged in the half space disposed in front of the slicing region is preferably provided in addition to the luminous frame or luminous tunnel. This radiation source can be arranged beneath the product support and preferably has an elongate shape extending transversely to the product conveying direction.

It is alternatively also possible in accordance with the invention for the lighting device exclusively to include radiation sources which are arranged in the half space disposed in front of the slicing region. A plurality of radiation sources spatially separated from one another can be provided. The use of only one single radiation source is also possible.

Further preferred embodiments both of the slicing method in accordance with the invention and of the slicing apparatus in accordance with the invention are recited in the claims, in the description and in the drawing.

The invention will be described in the following purely by way of example with reference to the drawing. There are shown:

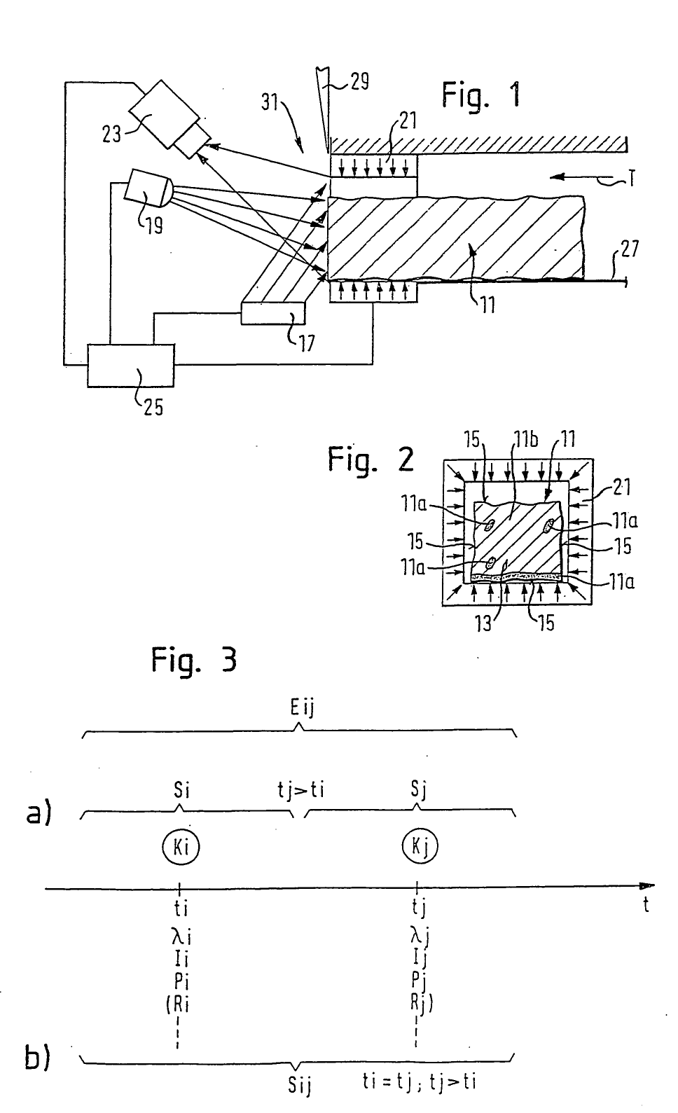

FIG. 1 a schematic side view of a slicing apparatus in accordance with an embodiment of the invention;

FIG. 2 schematically, a frontal view of the slicing region of the apparatus of FIG. 1; and

FIG. 3 a diagram for the explanation of slicing methods in accordance with the invention.

The apparatus in accordance with the invention shown in FIGS. 1 and 2 includes a machine for the slicing of food products 11, of which a product supply region with a product support surface 27 and a cutting blade 29 are shown only schematically, and an optoelectronic detection device 17, 19, 21, 23, 25 for the illumination of the slicing region 31 and for the detection and for the evaluation of electromagnetic radiation reflected from the slicing region 31.

The product 11, e.g. sausage or ham in loaf form, is fed in a conveying direction T in the direction of the slicing region 31 by means of a feeding device. Slices are cut off the product 11 in a fast sequence by means of the cutting blade 29 and portions are formed from these which are subsequently transported away from the slicing region 31. For reasons of clarity, the devices for the formation of portions and for the transporting away of the portions are not shown in FIGS. 1 and 2.

It is indicated in FIG. 1 that the outer contour of the product 11 varies over its length, whereas FIG. 2 shows components of the product 11a, 11b of different density—e.g. fat, on the one hand, and lean meat, on the other hand—which result in an irregular product structure with a distribution varying over the product length.

The optoelectronic detection device includes a lighting device with a plurality of radiation sources 17, 19, 21, a detection device 23, e.g. in the form of a color camera, for the detection of the reflected radiation and a central control and evaluation device 25 which is connected to the radiation sources 17, 19, 21 and to the detection device 23 and with which the individual components are controlled or read out in accordance with the respective detection method and the taken images or image data are stored, processed and evaluated in order to determine the contour and the structure of the product 11 during the slicing. Using the contour and structure data gained, specific operating parameters of the slicing machine, e.g. the slice thickness, can then be changed online during the slicing, for example by controlling corresponding adjustment elements, in order e.g. to keep the weight of slice portions to be formed from the cut-off slices constant within pre-determined limits. Changes to the product contour and structure can consequently be reacted to immediately.

Two radiation sources 17, 19 are arranged at the front side in the half space disposed in front of the slicing region 31, with the one radiation source 17 being arranged beneath the product support surface 27 at a comparatively small spacing from the cutting plane. The other radiation source 19 is located above the product support surface 27 at a larger spacing from the cutting plane.

A further radiation source 21 is made as the luminous frame completely surrounding the product 11 (cf. in particular FIG. 2) which extends up to just before the cutting plane in the product conveying direction T and forms a luminous tunnel for the product 11 to be sliced. The product 11 is illuminated from all sides by the luminous frame 21, whereby the environment or the marginal region 15 of the slice, whose respective front cut surface 13 is shown in FIG. 2, to be cut off from the product 11 is illuminated.

FIGS. 1 and 2 show only a possible embodiment of the lighting device. The number of the radiation sources and their spatial arrangement can generally be as desired. The luminous frame 21 can thus be dispensed with, for example, and the illumination of the slicing region 31 can take place exclusively by means of radiation sources arranged at the front side. The radiation source 17 arranged beneath the support surface 27 close to the cutting plane and formed e.g. as a luminous rod or as a luminous strip extending transversely to the product conveying direction T can be provided as the single radiation source.

In the preferred arrangement, however, a luminous frame or a luminous tunnel 21 is provided in conjunction with one or more radiation sources 17, 19 at the front side. The light frame 21 permits a so-called inverse illumination of the slicing region 31 or of the environment 15 of the product slices to be cut off in which—relative to the wavelength used with the luminous frame 21—the cut surface 13 of the product 11 stands out from the lighter marginal region 15 as a relatively dark area and a comparatively high contrast is produced between the cut surface 13 and the marginal region 15 which permits a reliable detection of the contour of the irregularly shaped product 11 by means of the detection device 23.

Generally any desired lighting apparatuses can be used for the radiation sources 17, 19, 21 which emit either visible light or radiation lying in the wavelength range invisible to the human eye. Lighting apparatuses operated either permanently or in a pulsed manner can be used. The use of LEDs is particularly preferred. Furthermore, the radiation sources can be designed movably, e.g. pivotably or displaceably, in order to be able to change the lighting direction and to thereby match it ideally to the respective conditions. The radiation sources can each be movable as a whole or individual lighting elements such as LEDs of the radiation sources can be moved independently of one another. The movement of the radiation sources can take place automatically. An automatically adjusting illumination can thus be realized e.g. by means of a regulation device which is able to react to changing environmental conditions.

To distinguish different illumination wavelengths, instead of a color camera, a plurality of black and white cameras can also be used which are each provided with a correspondingly matched filter device.

Different possibilities for the effecting of an illumination method in accordance with the invention, in which the aforesaid apparatus can be used, will be explained in the following with reference to FIG. 3.

When slicing a product, a plurality of individual detection procedures are carried out in series. Each detection procedure Eij in turn includes a plurality of illumination components, with—in the example shown—a component Ki taking place at the time ti and a component Kj taking place at he time tj being provided. Generally, any desired number of illumination components can respectively form one detection procedure.

In the variant (a), the illumination components Ki, Kj are effected on different product slices Si, Sj, preferably immediately following one another, i.e. tj>ti applies. However, the variant (b) is also possible in which the components Ki, Kj are effected on the same product slice Sij, i.e. the detection procedure Eij does not include a plurality of product slices, but only one single product slice Sij. The illumination components Ki, Kj can be effected either after one another timewise (tj>ti) or simultaneously so that ti=ti.

The illumination components Ki, Kj differ from one another at least with respect to an illumination parameter, and indeed, for example, with respect to the wavelength λ, to the intensity I and/or to the polarization properties of the radiation used. With the same intensity of the radiation sources, the illumination components can basically also differ from one another by the intensity of illumination produced in the respectively illuminated region which can also depend on other circumstances in addition to the radiation intensity.

Furthermore, the illumination components Ki, Kj can differ with respect to the direction R from which the respectively used illuminating radiation acts on the slicing region, with this illumination parameter being put in brackets in FIG. 3, since in the preferred variants of the method in accordance with the invention a differentiation of the illumination components Ki, Kj exclusively by the lighting direction R is not provided, although the lighting direction can basically be the only distinguishing illumination parameter in accordance with the invention.

Furthermore, it is possible in accordance with the invention for the illumination components Ki, Kj to differ from one another only by the time t of their being effected with the same wavelength λ, the same intensity I or the produced intensity of illumination and the same polarization properties.

In a particularly preferred variant in accordance with the invention, each detection procedure includes two product slices directly in series, with one illumination component being effected on each product slice and the illumination components differing from one another only with respect to the intensity of the radiation used or to the intensity of illumination produced therewith. Only a frontal lighting takes place in this process with one or more radiation sources arranged at the front side in the half space disposed in front of the slicing region. The slice contour is determined on the respective first slice with a comparatively high radiation intensity or intensity of illumination, whereas the lighting of the cut surface on the second product slice for the detection of the product structure takes place at a lower intensity or intensity of illumination. The contour and the structure are therefore determined on different product slices and assumed as respectively constant over two sequential slices.

In a further particularly preferred variant of the invention, alternatively or additionally to the intensity variation or intensity of illumination variation explained above, the wavelength of the radiation used is varied in each case from product slice to product slice. It is, for example, thus possible to work with light of different colors such that yellow light is used on a first slice for the contour determination and subsequently, for the structure determination, blue light is first used on a slice for one product component (for example fat) and red light is used on the next slice for another product component (for example lean meat).

In a further preferred variant in accordance with the invention, different wavelengths are in turn used, with all illumination components, however, being effected simultaneously and thus on the same product slice in each detection procedure. A color camera, for example, serves as the detection device for the radiation reflected from the slicing region or a plurality of individual sensors are used, e.g. black and white cameras each provided with a filter device. In this variant, a plurality of images are thus not taken on different slices for each detection procedure, as in the examples explained above, but each detection procedure includes the taking of a single image on a product slice.

In accordance with a further preferred variant of the invention, a plurality of images can be taken on a single slice in each detection procedure, with an illumination component being associated with each image and the illumination components being able to differ from one another by one or more illumination parameters, in particular by the wavelength and/or by the intensity of the radiation used or of the intensity of illumination thus produced. In comparison with the variant explained above, a higher image frequency is used in this process since the illumination components following one another timewise are effected on a single slice. In particular with high-performance slicing machines, the detection device must be capable of a particularly fast taking and storing of the image data.

The individual illumination components can either be effected with a single radiation source or be spread over a plurality of radiation sources spatially separate from one another. For the detection of the reflected radiation, instead of a single sensor, a plurality of individual sensors can be provided which are each associated with an illumination component.

If a plurality of images are taken for each detection procedure and are each associated with one or more illumination components, the individual images are put together by means of the control and evaluation device to form one total image which contains information both on the contour and on the structure of the respective section of the product including either one or more product slices.

1-38. (canceled)

39. A method for the slicing of food products having an irregular inner structure such as sausage or ham, in which the products (11) are cut into slices (S) and in particular overlapping portions or stacked portions are formed and transported away from the slicing region (31) and in which information is gained on the contour and on the structure of the product slices (S) during slicing by means of an optoelectronic detection device in a series of detection procedures (E), in that the slicing region (31) is illuminated and illuminating radiation reflected from the cut surfaces (13) of the respective slices (S) to be cut off from the product (11) and reflected from the marginal region (15) of the slices (S) is detected and evaluated,
characterized in that,
in at least one detection procedure (E), and preferably in each detection procedure (E), the illumination is effected in a plurality of direction-independent components (K) which differ from another at least with respect to one illumination parameter.

40. A method in accordance with claim 39, characterized in that at least some illumination components (K) are effected simultaneously.

41. A method in accordance with claim 39, characterized in that at least some illumination components (K) are effected after one another timewise.

42. A method in accordance with claim 39, characterized in that at least some illumination components (K) differ with respect to the wavelength (λ) of the radiation used.

43. A method in accordance with claim 39, characterized in that the wavelengths (λ) are selected in dependence on the different components of the product (11a, 11b), in particular on the fat component, on the one hand, and on the lean component, on the other hand, and/or on whether the slice structure or the slice contour should be detected.

44. A method in accordance with claim 39, characterized in that at least some illumination components (K) differ from one another with respect to the intensity (I) of the radiation used and/or with respect to the intensity of illumination produced in the respectively illuminated region.

45. A method in accordance with claim 39, characterized in that at least some illumination components (K) differ from one another with respect to the polarization properties (P) of the radiation used.

46. A method in accordance with claim 39, characterized in that the or each detection procedure (E) includes precisely one product slice (S).

47. A method in accordance with claim 39, characterized in that the or each detection procedure (E) includes a plurality, and in particular two or three directly sequential product slices (S).

48. A method in accordance with claim 39, characterized in that pieces of information gained at one or different product slices (S) are put together to form joint information on both the contour and the structure of the product slices (S).

49. A method in accordance with claim 39, characterized in that information is gained on one product slice (S) about its structure and on another product slice (S) about its contour.

50. A method in accordance with claim 39, characterized in that information is gained on the different components of the product (11a, 11b), in particular on the fat component, on the one hand, and on the lean component, on the other hand, on different product slices (S).

51. A method in accordance with claim 39, characterized in that a plurality of illumination components (K), and in particular all illumination components (K) are effected from a single direction (R) and in particular by means of a single radiation source.

52. A method in accordance with claim 39, characterized in that the illumination components (K) are effected from different directions (R) and in particular by means of a plurality of radiation sources (17, 19, 21) spatially separated from one another.

53. A method in accordance with claim 39, characterized in that, for the production of the contrast between the cut surface (13) and its marginal region (15), a higher intensity of illumination is produced in the latter than on the cut surface (13).

54. A method for the slicing of food products having an irregular inner structure such as sausage or ham, in which the products (11) are cut into slices (S) and in particular overlapping portions or stacked portions are formed and transported away from the slicing region (31) and in which information is gained on the contour and on the structure of the product slices (S) during slicing by means of an optoelectronic detection device in a series of detection procedures (E), in that the slicing region (31) is illuminated and illuminating radiation reflected from the cut surfaces (13) of the respective slices (S) to be cut off from the product (11) and reflected from the marginal region (15) of the slices (S) is detected and evaluated, characterized in that in at least one detection procedure (E), and preferably in every detection procedure (E), the illumination is effected only from the half space disposed in front of the slicing region (31) in a plurality of illumination components (K) from different directions.

55. A method in accordance with claim 54, characterized in that at least some illumination components (K) are effected simultaneously.

56. A method in accordance with claim 54, characterized in that at least some illumination components (K) are effected after one another timewise.

57. A method in accordance with claim 54, characterized in that at least some illumination components (K) differ with respect to the wavelength (λ) of the radiation used.

58. A method in accordance with claim 54, characterized in that the wavelengths (λ) are selected in dependence on the different components of the product (11a, 11b), in particular on the fat component, on the one hand, and on the lean component, on the other hand, and/or on whether the slice structure or the slice contour should be detected.

59. A method in accordance with claim 54, characterized in that at least some illumination components (K) differ from one another with respect to the intensity (I) of the radiation used and/or with respect to the intensity of illumination produced in the respectively illuminated region.

60. A method in accordance with claim 54, characterized in that at least some illumination components (K) differ from one another with respect to the polarization properties (P) of the radiation used.

61. A method in accordance with claim 54, characterized in that the or each detection procedure (E) includes precisely one product slice (S).

62. A method in accordance with claim 54, characterized in that the or each detection procedure (E) includes a plurality, and in particular two or three directly sequential product slices (S).

63. A method in accordance with claim 54, characterized in that pieces of information gained at one or different product slices (S) are put together to form joint information on both the contour and the structure of the product slices (S).

64. A method in accordance with claim 54, characterized in that information is gained on one product slice (S) about its structure and on another product slice (S) about its contour.

65. A method in accordance with claim 54, characterized in that information is gained on the different components of the product (11a, 1b), in particular on the fat component, on the one hand, and on the lean component, on the other hand, on different product slices (S).

66. A method in accordance with claim 54, characterized in that a plurality of illumination components (K), and in particular all illumination components (K) are effected from a single direction (R) and in particular by means of a single radiation source.

67. A method in accordance with claim 54, characterized in that the illumination components (K) are effected from different directions (R) and in particular by means of a plurality of radiation sources (17, 19, 21) spatially separated from one another.

68. A method in accordance with claim 54, characterized in that, for the production of the contrast between the cut surface (13) and its marginal region (15), a higher intensity of illumination is produced in the latter than on the cut surface (13).

69. An apparatus for the slicing of food products having an irregular inner structure such as sausage or ham, with which the products (11) are cut into slices (S) and in particular overlapping portions or stacked portions are formed and transported away from the slicing region (31), there being
a lighting device including at least one radiation source (17, 19, 21) for the illumination of the slicing region (31),
a detection device (23) for illuminating radiation reflected from the cut surfaces (13) of the respective slices (S) to be cut off from the product (11) and from the marginal region (15) of the slices (S), and
an evaluation device (25) for the evaluation of the detected radiation,
characterized in that
the lighting device for the production of a contrast sufficient for the detection of the contour and of the structure of the product slices (S) between the cut surface (13) and its marginal region (15), on the one hand, and between different portions of the product (11a, 11b) on the cut surface (13), on the other hand, is operable such that the illumination can be effected in at least one detection procedure (E) and preferably in each detection procedure (E) in a plurality of detection-independent components (K) which differ from one another at least with respect to an illumination parameter.

70. An apparatus in accordance with claim 69, characterized in that at least some illumination components (K) can be effected simultaneously with the lighting device.

71. An apparatus in accordance with claim 69, characterized in that at least some illumination components (K) can be effected after one another timewise with the lighting device.

72. An apparatus in accordance with claim 69, characterized in that the lighting device is made for the transmission of radiation of different wavelengths (λ).

73. An apparatus in accordance with claim 69,
characterized in that the lighting device is made for the transmission of radiation of different intensities (I).

74. An apparatus in accordance with claim 69, characterized in that the lighting device is made for the transmission of radiation of different polarization properties (P).

75. An apparatus in accordance with claim 69, characterized in that the lighting device includes precisely one radiation source.

76. An apparatus in accordance with claim 69, characterized in that the lighting device includes a plurality of radiation sources (17, 19, 21) spatially separate from one another.

77. An apparatus in accordance with claim 69,
characterized in that at least one radiation source (17, 19), or each radiation source (17, 19) is arranged in the half space disposed in front of the slicing region (31).

78. An apparatus in accordance with claim 77, characterized in that at least one radiation source (17) is arranged beneath the product support surface (27) and is in particular of an elongate shape extending transversely to the product conveying direction (T).

79. An apparatus in accordance with claim 69, characterized in that the lighting device includes a luminous frame or luminous tunnel (21) arranged at least partly in the slicing region (31) and partly or fully surrounding the product (11) in operation.

80. An apparatus in accordance with claim 79, characterized in that the lighting device includes, in addition to the luminous frame or luminous tunnel (21), at least one radiation source (17, 19) arranged in the half space disposed in front of the slicing region (31).

81. An apparatus in accordance with claim 69, characterized in that the radiation source (17, 19, 21) is movable for the changing of the lighting direction.

82. An apparatus in accordance with claim 69, characterized in that the detection device (23) includes at least one sensor which is associated with a plurality of illumination components (K) and in particular with all illumination components (K).

83. An apparatus in accordance with claim 69, characterized in that at least one sensor of the detection device (23) is provided for the simultaneous detection of radiation of different wavelengths (λ) and is in particular provided in the form of a color camera.

84. An apparatus in accordance with claim 69, characterized in that the detection device (23) includes a plurality of individual sensors which are associated with different illumination components (K).

85. An apparatus in accordance with claim 69, characterized in that individual sensors of the detection device (23) are provided in each case in the form of a black and white camera provided with filter devices.

86. An apparatus in accordance with claim 69, characterized in that at least one sensor of the detection device (23) can be read out repeatedly in accordance with a time sequence of illumination components (K).

87. An apparatus in accordance with claim 69, characterized in that a plurality of individual sensors of the detection device (23) can be read out after one another timewise in accordance with a time sequence of illumination components (K).

88. An apparatus for the slicing of food products having an irregular inner structure such as sausage or ham, with which the products (11) are cut into slices (S) and in particular overlapping portions or stacked portions are formed and transported away from the slicing region (31), there being
a lighting device including at least one radiation source (17, 19, 21) for the illumination of the slicing region (31),
a detection device (23) for illuminating radiation reflected from the cut surfaces (13) of the respective slices (S) to be cut off from the product (11) and from the marginal region (15) of the slices (S), and
an evaluation device (25) for the evaluation of the detected radiation,
characterized in that the lighting device includes only radiation sources which are arranged in the half space disposed in front of the slicing region (31) and with which the illumination can be effected in a plurality of illumination components (K) from different directions.

89. An apparatus in accordance with claim 88, characterized in that at least some illumination components (K) can be effected simultaneously with the lighting device.

90. An apparatus in accordance with claim 88, characterized in that at least some illumination components (K) can be effected after one another timewise with the lighting device.

91. An apparatus in accordance with claim 88, characterized in that the lighting device is made for the transmission of radiation of different wavelengths (λ).

92. An apparatus in accordance with claim 88,
characterized in that the lighting device is made for the transmission of radiation of different intensities (I).

93. An apparatus in accordance with claim 88, characterized in that the lighting device is made for the transmission of radiation of different polarization properties (P).

94. An apparatus in accordance with claim 88, characterized in that the lighting device includes precisely one radiation source.

95. An apparatus in accordance with claim 88, characterized in that the lighting device includes a plurality of radiation sources (17, 19, 21) spatially separate from one another.

96. An apparatus in accordance with claim 88,
characterized in that at least one radiation source (17, 19), or each radiation source (17, 19) is arranged in the half space disposed in front of the slicing region (31).

97. An apparatus in accordance with claim 96, characterized in that at least one radiation source (17) is arranged beneath the product support surface (27) and is in particular of an elongate shape extending transversely to the product conveying direction (T).

98. An apparatus in accordance with claim 88, characterized in that the lighting device includes a luminous frame or luminous tunnel (21) arranged at least partly in the slicing region (31) and partly or fully surrounding the product (11) in operation.

99. An apparatus in accordance with claim 98, characterized in that the lighting device includes, in addition to the luminous frame or luminous tunnel (21), at least one radiation source (17, 19) arranged in the half space disposed in front of the slicing region (31).

100. An apparatus in accordance with claim 88, characterized in that the radiation source (17, 19, 21) is movable for the changing of the lighting direction.

101. An apparatus in accordance with claim 88, characterized in that the detection device (23) includes at least one sensor which is associated with a plurality of illumination components (K) and in particular with all illumination components (K).

102. An apparatus in accordance with claim 88, characterized in that at least one sensor of the detection device (23) is provided for the simultaneous detection of radiation of different wavelengths (λ) and is in particular provided in the form of a color camera.

103. An apparatus in accordance with claim 88, characterized in that the detection device (23) includes a plurality of individual sensors which are associated with different illumination components (K).

104. An apparatus in accordance with claim 88, characterized in that individual sensors of the detection device (23) are provided in each case in the form of a black and white camera provided with filter devices.

105. An apparatus in accordance with claim 88, characterized in that at least one sensor of the detection device (23) can be read out repeatedly in accordance with a time sequence of illumination components (K).

106. An apparatus in accordance with claim 88, characterized in that a plurality of individual sensors of the detection device (23) can be read out after one another timewise in accordance with a time sequence of illumination components (K).
